(19) United States
(12) Patent Application Publication
(10) Pub. No.: US 2008/0295287 A1
(43) Pub. Date: Dec. 4, 2008

(54) Releasable Hinge

(76) Inventor: Mark Hetherington, Cumbria (GB)

Correspondence Address: JOHN S. PRATT, ESQ;KILPATRICK STOCKTON, LLP, 1100 PEACHTREE STREET, ATLANTA, GA, 30309, US

(21) Appl. No.: 12/119,881

(22) Filed: May 13, 2008

(30) Foreign Application Priority Data
Jun. 4, 2007 (GB) 0710613.1

(51) Int. Cl. E05D 7/10

(52) U.S. Cl. 16/262

(57) ABSTRACT

Improved hinge mechanisms and hinge systems releasably conjoin elements such as doors, frames and panels. The hinges include multiple pins that can be moved to a first position in which the hinge leaves may be separated from one another, and a second position in which the hinge leaves are pivotally secured to one another.

### RELATED APPLICATIONS

This application claims the benefit of the filing date of UK Patent Application No. 0710613.1, filed Jun. 4, 2007 for a “Releasable Hinge,” the entire contents of which is hereby incorporated in its entirety by this reference.

### RELATED FIELDS

Embodiments of the present invention relate to hinge mechanisms and, in particular, to improved hinge mechanisms for releasably conjoining elements such as doors, frames and panels.

### BACKGROUND

Hinges are well known and have been used for many years to join sections of panel or doors/windows to frames etc. Hinges generally comprise two castellated plates which intermesh with each other along their castellated edges, with each castellated edge forming one or more sleeves. Typical hinges use an elongated pin extending through all of the intermeshed sleeves to pivotably secure the two plates together.

There are certain circumstances where it becomes desirable to separate the two plates of the hinge. For example, when moving home it is often desirable to, at least partially, dismantle furniture. The easy separation of hinged elements, such as doors from cabinets, will reduce the likelihood of damage to furniture and can also make the transportation of the furniture easier. This is particularly relevant in the case of “flat-pack” type furniture, which once assembled will not easily withstand the pressures of transportation as the joints are often of limited strength.

There are also circumstances where it is desirable to alternate a hinge from one side of a panel to another side—for example if a door is to be changed from a right hand opening door to a left hand opening door. Typically this is done by completely removing the hinge from one side and reinstalling it at the other side. However, if regular changes are required, standard castellated plates can be provided on both the left and right side, and the elongate pin can be used to interlock only the desired side as required.

In each of the above cases, if a hinge is to be separated, then the elongate pin must be removed and the castellated plates disengaged from each other. Whilst this is a very simple solution, a common problem with a standard hinge is that the elongate pin is misplaced when the plates are disengaged. The castellated plates are then unable to lock together in the absence of the elongate pin.

It would therefore be desirable to provide a releasable or separable hinge that obviates or mitigates some of the problems associated with the prior art.

### SUMMARY

According to some embodiments of the present invention there may be provided a hinge comprising:

a pair of inter-engaging hinge plates, each plate adapted to be secured to a surface and each plate having castellated sleeve sections along the engaging edge oriented such that each sleeve extends along the engaging edge;

one or more pins located within one or more of the castellated sleeve sections, each pin having substantially the same length as a castellated sleeve section;

wherein, when the hinge plates are inter-engaged, the pins are adapted to move in an axial direction when pressure is applied to one end of a pin, such that each pin moves to partially extend from a first castellated sleeve section into a second castellated sleeve section, thus interlocking the two castellated sleeve sections together;

and wherein the number of pins is less than the number of castellated sleeve sections.

The simple application of pressure to one end of a pin pushes it axially in one direction or the other causing a “cascade” of movement of all of the pins as the first pushes the next and so on. This allows an easy transition between the locked state in which the plates are locked in a conjoined formation and the open or released state which allows the plates to be separated. Advantageously, in some embodiments, providing separate pins of substantially the same length as a castellated sleeve sections may ensure that when the hinge plates are disengaged the pins are held within the sleeve sections and so will not be lost or misplaced.

Preferably the outer circumference of each pin is only fractionally smaller than the inner circumference of a castellated sleeve section such that the pins are held within the castellated sleeve sections.

Advantageously the pins will not move axially when held in this manner unless pressure is applied and thus the pins will not “slide out” when the hinge plates are separated. In some embodiments, the sizing of the pin and bore may be carefully selected to ensure that the pin does not move unless pressure is applied, but will move without too much pressure being required.

Preferably the pins do not extend out beyond the hinge.

Preferably, in some embodiments, there are no pins within at least one of the distal and/or proximal sleeve sections of the hinge when the pins are in the open or released state.

The advantage of leaving the distal and/or proximal castellated sleeve sections free from pins is that, when the pins are moved to the locked position by applying pressure to one end, the pins will not protrude out with the plate.

Preferably, in some embodiments, the hinge is provided with an elongate key element adapted to fit into the proximal or distal sleeve sections to contact the pins.

Preferably, in some embodiments, the key element comprises an elongate section that is able to fit into the proximal or distal sleeve section and a top section that has a circumference wider than the proximal or distal sleeve section such that the top section cannot fit into the sleeve section.

In use, the elongate section is pushed into the proximal or distal sleeve section until the top section of the key element abuts against a surface of the hinge.

The length of the proximal sleeve section may differ from the length of the distal sleeve section.

This conveniently allows for the pins to be moved to the release position by the full insertion of a key element at one end and to the locked position by the full insertion of the key element at the other end.

Optionally the hinge may comprise a plurality of pairs of inter-engaging hinge plates.

Optionally the hinge plates may have a plurality of castellated engaging edges.

Providing a plurality of castellated engaging edges allows the hinge plates to be conjoined in a number of different arrangements.

Preferably the pins may be provided with chamfered edges.

### BRIEF DESCRIPTION OF THE DRAWINGS

In order to provide a better understanding of the present invention an embodiment will be described, by way of example only, and with reference to the following figures, wherein;

FIG. 1 is an exploded perspective view of a hinge according to one embodiment of the present invention; and

FIG. 2 is a section view of the hinge of FIG. 1 where the hinge is in the closed/locked position; and

FIG. 3 is a section view of the hinge of FIG. 1 where the hinge is in the open/release position; and

FIG. 4 is a perspective view of a key element according to one embodiment of the present invention.

### DETAILED DESCRIPTION OF THE DRAWINGS

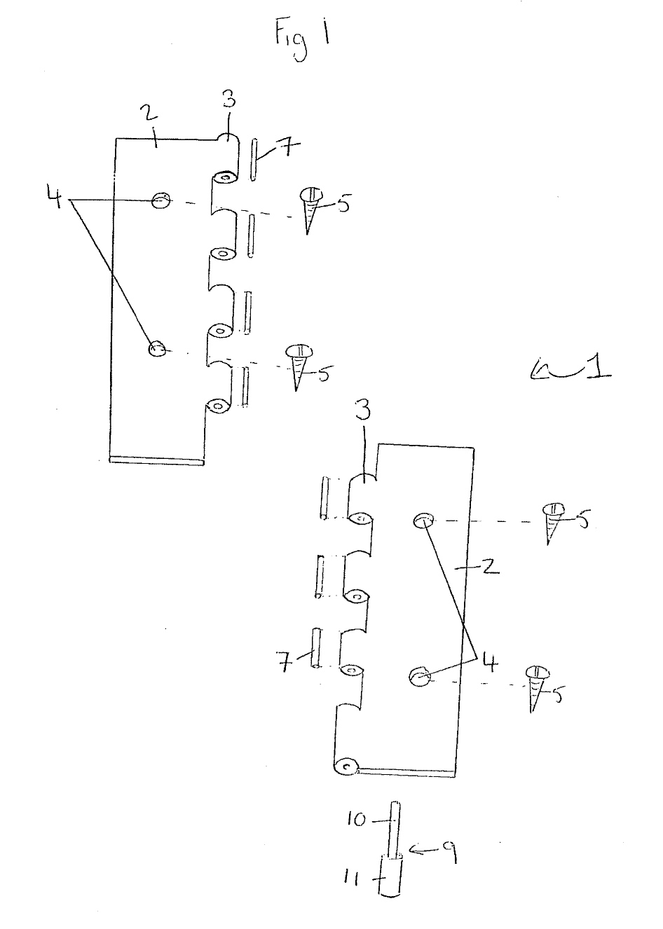

A hinge 1 is generally depicted in FIG. 1. The hinge 1 is made up of two opposing hinge plates 2 each of which have a series of castellated sleeve sections 3 arranged along their engaging edge. Each sleeve section 3 is a tubular member which has a bore running axially through it in the direction of the engaging edge. Each hinge plate 2 is also provided with a plurality of apertures 4 through which a screw 5 or other suitable fastener can be placed to fix the hinge plate 2 to a surface.

Although in the preferred embodiment the bores of the sleeve sections 3 are of circular cross section it is clear that the bore could be of any appropriate cross-section.

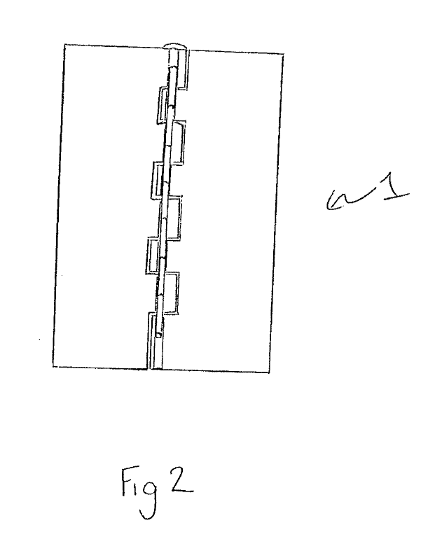

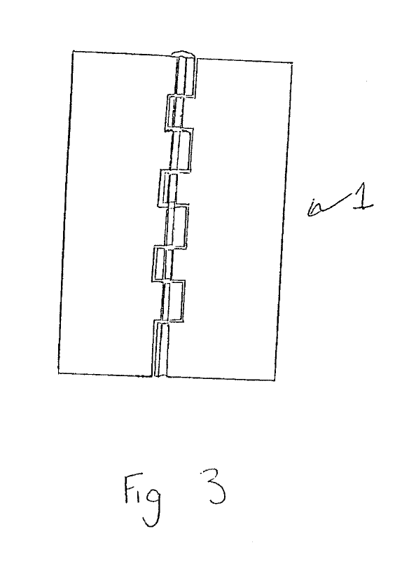

In use, the hinge plates 2 are aligned such the castellated edges inter-mesh to form the hinge 1. Each of the sleeve sections 3 in the hinge 1, other than the lowermost sleeve section (depicted as 3a) is provided with a pin 7 running axially the length of the sleeve section. In the unlocked position shown in FIG. 3, where the hinge plates 2 can be separated, the pins 7 are housed entirely within the sleeve sections 3. As can be seen in FIGS. 2 and 3, the pins 7 are substantially the same length as the sleeve section 3 with which they are associated. In the preferred embodiment the pins 7 are in the form of small metal rods of circular cross section and are of a size such that they will fit into the sleeve sections 3 by interference fit. This tight fit means that they will not move within the sleeve section 3 unless pressure is applied to one end of the pin 7.

In order to ensure the interference fit is achieved, the internal surface of the sleeve elements can be at least partially formed of rubber or lined with other such resilient material. As the rubber is a resilient material it will grip a pin which is of approximately the same circumference as the internal circumference of the sleeve elements.

Although in the preferred embodiment the pins are held in the sleeve elements by interference fit, in some embodiments, it would be possible to provide a locking mechanism to hold the pins in place. This locking mechanism could take the form of pegs inserted through one or more of the pins and the wall of the sleeve section. Alternatively it could take the form of a reduction or increase in the bore size of the sleeve members as required.

In order to lock the hinge plates 2 together when they are in their inter-engaged position, the pins 7 are caused to move such that they extend partway out from a first sleeve section 3 and into a second sleeve section 3 (as can be seen in FIG. 2). As each pin 7 extends across the boundary between two neighbouring sleeve sections 3, the hinge plates 2 cannot then be pulled apart. In some embodiments, the pins 7 are provided with chamfered or bevelled edges 8, and this allows for a situation where the neighboring sleeve sections 3 are not in exact alignment.

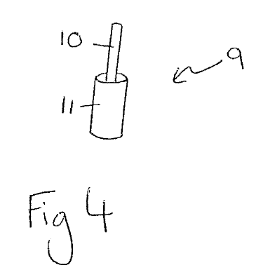

In order to move the pins 7 from their first position where they are held completely within the sleeve sections 3 (and the hinge is in its open or release position), to their second position where they extend out-with a first sleeve section 3 into a neighbouring sleeve section 3 (such that the hinge is in its closed or locked position), a key 9 is used. The key 9, generally depicted in FIG. 4, is made up of an elongate element 10 which contacts a pin 7 and a top-section 11 which the user can hold. The elongate element 10 has a circumference slightly less that that of the bores running through the sleeve elements 3 such that it can be easily inserted into a sleeve element 3. Conversely, the top-section 11 has a circumference larger than that of the bores running through the sleeve elements 3. This (or other) configurations of the key 9 ensure that the elongate element can only be inserted partway into the channel or bore that is formed by the inter-engagement of the castellated sleeve sections 3 before the top-section 11 of the key 9 abuts against an edge of the hinge.

In one preferred embodiment, the lowermost sleeve section 3a is longer than the other sleeve sections 3 that make up the hinge 1. In this case it is 50% longer that the other sections. Furthermore, as mentioned above, the lowermost sleeve section 3a does not have a pin 7 associated with it when the hinge 1 is in the open or unlocked position. The elongate element 10 of the key 9 is substantially the same length as the lowermost sleeve section 3a. When the key is inserted downwardly into the uppermost sleeve section (depicted as 3b) the elongate element 10 contacts a pin 7 and pushes it axially down through the sleeve section 3 in which it resides when the hinge 1 is in the open or release position and particularly into the next sleeve section. The key 9 is inserted fully such that the top-most section 11 abuts against the hinge 1 and the elongate section 10 is fully contained within the castellated sleeve sections 3. As the elongate section 10 is 50% longer than the uppermost sleeve section 3b its insertion causes the pin to be pushed to a position, as can be seen in FIG. 3, where it overlaps the boundary between two neighbouring sleeve sections 3. As there are a number of pins 7 aligned together in the inter-engaged hinge 1, each pin 7 is pushed by the “preceding” pin to also extend across a boundary between neighbouring sleeve sections 3. The hinge plates 2 that make up the hinge 1 are then unable to be parted when the pins 7 are so positioned, as a sleeve section 3 from one hinge plate 2 is connected via a pin to a sleeve section 3 from the opposing hinge plate 2.

When the hinge 1 is locked the key 9 may be left in position or can be removed. When in the locked or closed position the hinge 1 will act in a conventional manner. As none of the pins 7 will protrude from hinge 1, the hinge 1 cannot accidentally be moved to open or release position.

In order to unlock the hinge 1 such that the hinge plates 2 can simply be pulled apart, the key 9 is then fully inserted into the lowermost sleeve section 3a. As the elongate element 10 is the same length as the lowermost sleeve section 3a this contacts the pin which is currently straddling the boundary between the lowermost sleeve element 3a and its neighbour, and pushes it axially upwards. When the elongate element 10 is fully inserted, the pin 7 which it contacts is positioned entirely within a sleeve element 3 and does not extend across boundaries between sleeve elements. Thus the hinge plates can be separated simply by pulling them apart.

It will be clear to one skilled in the art that the length of the elongate element simply needs to be such that when inserted into the sleeve at one end of the hinge it will align the pins within the sleeve elements and when inserted at the other end it will misalign the pins such that they will overlap neighbouring sleeve elements to hold the hinge plates together.

Furthermore, modifications to the above example may be made without departing from the scope of the invention herein intended. In particular, although the description above described a pair of hinge plates, multiple pairs of hinge plates could be used to make up a hinge. Also, the invention is not limited by particular materials providing that they are suitable for the use to which they are put, for example it is well known in the art that a wide variety of metallic and plastic materials can be utilized for hinge manufacture.

We claim:

1. A hinge, comprising:
(a) at least a pair of hinge plates, each hinge plate comprising at least one sleeve, at least some of the sleeves defining elongated bores; and
(b) at least one elongated pin at least partially positioned within at least one of the elongated bores, wherein a length of the elongated pin is substantially equal to, or less than, a length of the elongated bore the elongated pin is at least partially positioned within;
wherein positioning the elongated pin such that it is at least partially positioned in at least two of the bores pivotally secures the pair of hinge plates together, and wherein positioning the at least one elongated pin such that it is positioned in only one of the bores allows the hinge plates to be disconnected.

2. The hinge of claim 1, wherein each hinge plate comprises a plurality of sleeves and wherein the at least one elongated pin comprises a plurality of elongated pins; wherein positioning the plurality of elongated pins such that each pin is positioned in at least two of the bores pivotally secures the pair of hinge plates together, and wherein positioning the plurality of elongated pins such that each pin is positioned in only one of the bores allows the hinge plates to be disconnected.

3. The hinge of claim 2, wherein the number of pins is less than the number of sleeves.

4. The hinge of claim 3, wherein a distal sleeve does not include a pin when the hinge plates are disconnected.

5. The hinge of claim 4, wherein the distal sleeve is at least somewhat longer than the other sleeves.

6. A hinging system, comprising:
(a) a hinge, comprising: (i) at least a pair of hinge plates, each hinge plate comprising at least one sleeve, at least some of the sleeves defining elongated bores; and (ii) at least one elongated pin at least partially positioned within at least one of the elongated bores, wherein a length of the elongated pin is substantially equal to, or less than, a length of the elongated bore the elongated pin is at least partially positioned within; wherein positioning the elongated pin such that it is at least partially positioned in at least two of the bores pivotally secures the pair of hinge plates together, and wherein positioning the at least one elongated pin such that it is positioned in only one of the bores allows the hinge plates to be disconnected; and
(b) a key comprising an elongate section, wherein positioning the elongated section at least partially within one of the sleeves moves the elongated pin such that it is at least partially positioned in at least two of the bores and wherein positioning the elongated section at least partially within another one of the sleeves moves the elongated pin such that it is positioned in only one of the bores.

7. The hinging system of claim 6:
wherein each hinge plate comprises a plurality of sleeves and wherein the at least one elongated pin comprises a plurality of elongated pins;
wherein positioning the plurality of elongated pins such that each pin is positioned in at least two of the bores pivotally secures the pair of hinge plates together; and
wherein positioning the plurality of elongated pins such that each pin is positioned in only one of the bores allows the hinge plates to be disconnected.

8. The hinging system of claim 7:
wherein positioning the elongated section of the key at least partially within one of the sleeves moves the elongated pins such that each pin is at least partially positioned in at least two of the bores; and
wherein positioning the elongated section at least partially within another one of the sleeves moves the elongated pins such that each pin is positioned in only one of the bores.
